(19) United States
(12) Patent Application Publication
(10) Pub. No.: US 2009/0269129 A1
(43) Pub. Date: Oct. 29, 2009

(54) Joint With Increased Splay Angle

(76) Inventor: Heiko Harnischfeger, Freiensteinau-Weidenau (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/914,384

(22) PCT Filed: Apr. 15, 2006
(86) PCT No.: PCT/EP06/03482

§ 371 Date: Jun. 30, 2008

(30) Foreign Application Priority Data
May 13, 2005 (DE) 102005023035.0

(51) Int. Cl. F16D 3/224

(52) U.S. Cl. 403/125

(57) ABSTRACT

A constant velocity universal joint (11) having an outer joint part (12) with outer ball tracks (19), an inner joint part (15) with inner ball tracks (20), torque transmitting balls (21) which are held in pairs of outer and inner ball track (19, 20) associated with one another, and having a ball cage (23) which receives the balls (21) in cage windows (22) and holds same in a common central plane K, wherein the course of the outer ball tracks (19) and the course of the inner ball tracks (20) associated with one another extend mirror-symmetrically relative to the central plane K of the constant velocity universal joint, wherein, at one kind of the outer and inner ball tracks (19, 20), at least one axial end portion (34) each, the track shape is such that a ball (21) entering said axial end portion (34) when the joint is articulated is freed from the transmission of torque between the associated outer and inner ball tracks (19, 20).

The invention relates to a constant velocity universal joint (11) having an outer joint part with outer ball tracks, an inner joint part with inner ball tracks, torque transmitting balls which are held in pairs of outer and inner ball track associated with one another, and having a ball cage which receives the balls in cage windows and holds same in a common central plane K, wherein the course of the outer ball tracks and the course of the inner ball tracks associated with one another extend mirror-symmetrically relative to the central plane K of the constant velocity universal joint. Said mirror-symmetrical way in which the courses of the tracks extend refers to the longitudinal centre lines of the ball tracks, which longitudinal centre lines correspond to the path of the ball centres in the ball tracks. The plane which is formed by the intersecting longitudinal axes of the outer joint part and of the inner joint part is referred to as the articulation plane of the constant velocity universal joint. Said two longitudinal axes enclose the articulation angle which is bisected by the centre plane K.

Joints of the type referred to here are provided in the form of fixed ball joints, more particularly in such a way that the ball tracks are non-uniformly spaced around the circumference, so that webs of different widths are produced between adjoining ball tracks. The pairs of tracks adjoining one another herein extend in parallel planes, with the webs positioned between the ball tracks of said pairs of tracks constitute those with the smaller widths. Furthermore, the adjoining balls held in said pairs of tracks can be held in a common cage window. Joints of said type are referred to by the applicant as “twin ball joints”.

Irrespective of the above-mentioned special track shape, the flanks of the ball tracks of fixed ball joints, when subjected to torque loads, are substantially loaded by pressure. The highest loads occur when the joint is articulated at the flanks of the ball tracks which are positioned in or near the articulation plane, wherein the balls in this condition act on the axial ends of the ball tracks. Especially when the balls with respect to their ball contact points, approach the track edges at the open end of the ball tracks, the hardened material at the track edges may split off. More particularly, this applies to conditions on the outer joint part wherein the ball tracks of the outer joint part are shortened relative to corresponding ball tracks at the inner joint part by an inner opening cone in the opening of the outer joint part. Said opening cone is required in order to provide—when the joint is articulated—freedom of movement for a plug-in shaft which is connected to the inner joint part. The larger the opening cone, the thicker the plug-in shaft can be in order to increase strength, or the larger the maximum opening angle of the joint can be. The desired increase in the opening angle increases the risk of damage to the track edges at the axial ends of the outer ball tracks at the opening end of the outer joint part.

It is therefore the object of the present invention to improve joints of said type in such a way that the risk of damage to the axial ends of the ball tracks is reduced. The objective is achieved in that at least one kind of the outer and inner ball tracks, at least one axial end portion each, the track shape is such that a ball entering said axial end portion when the joint is articulated is freed from the transmission of torque between the associated outer and inner ball tracks, i.e. freed from the simultaneous contact with track flanks of the inner and outer ball tracks, which track flanks are positioned diagonally opposite one another relative to the ball. The inventive solution ensures that in the flank regions in which originally there existed a risk of fracture at the end edges of the ball tracks, there is no ball engagement and no torque load as a result of the relative deviation of the inter-acting end regions of the outer and inner ball tracks i.e. as a result of the deviation of the end region of the one ball track from a matching shape of the opposite end region of the respective other ball track. In this embodiment, the torque load is transferred to balls and pairs of tracks which are positioned outside the articulation plane and in which, as a result, the balls are further removed from the track edges at the open track ends. The risk of edge fracture at the ball tracks is thus eliminated not by changing the strength conditions, but by changing the distribution of load among the individual balls and pairs of tracks.

In an advantageous way, it is therefore possible to use an opening cone at the outer joint part, which opening cone practically coincides with the point of contact of a ball in the articulation plane with the track flank because, in this region, the track flank takes on merely a guiding function for the ball, but is not under torque load. This means that an inner opening cone in the opening of the outer joint part, at most, is large enough for the conical face to be reached by the point of contact of the balls with the track flanks of the outer ball tracks at maximum articulation, but does not go any further.

According to a preferred embodiment it is proposed that at one kind of the outer and inner ball tracks, the course of the tracks of the axial end portions is deepened relative to a theoretical track course which is mirror-symmetrical with respect to the tracks of the associated inner or outer ball tracks. This is advantageous, especially from a production point of view, because the chip-removing tools for the ball tracks can be used without having to be modified, with only the control curves having to be changed.

According to an alternative embodiment it is proposed that at one kind of the outer and inner ball tracks, the track cross-section of the axial end portions is widened relative to a theoretical cross-section which would receive the balls with the track cross-section of the associated inner or outer ball tracks in a play-free way. This can be achieved in that inner and outer ball tracks which are symmetrical relative to one another can be machined by a first tool with the same control curves, but that the at least one end portion of one of the kinds of outer or inner ball tracks is subsequently machined by a larger tool.

According to a special embodiment it is proposed that the ball tracks of one kind of the outer and inner ball tracks extend in an S-like way and that the axial end portion of the other kind of outer and inner ball tracks is deepened in the shape of a straight tangential run-out. More particularly, it is proposed that the outer joint part is closed on one side by a base and that said axial end portion is provided at the end of the outer ball tracks facing the aperture or at the end of the inner ball tracks facing the base.

If the invention is applied to so-called disc joints, whose outer joint part comprises openings at both axial ends, the inventive idea can be applied to both end regions of the ball tracks in question.

A type of joint also shown in the drawing is characterised in that the ball tracks are spaced non-uniformly around the circumference, so that webs of different widths are provided between adjoining ball tracks. It is proposed that at least two balls each are arranged in a common cage window and that the webs with the smaller width are positioned between ball tracks of balls which are arranged in a common cage window. More particularly, it is proposed that there are provided eight balls which are arranged in four cage windows. It is proposed that the ball tracks which are separated by a web of a smaller width extend in planes E1, E2 extending parallel relative to one another.

There is thus described the application of the inventive characteristics to a twin ball joint with a total of eight S-shaped ball tracks, such as it is used in practice.

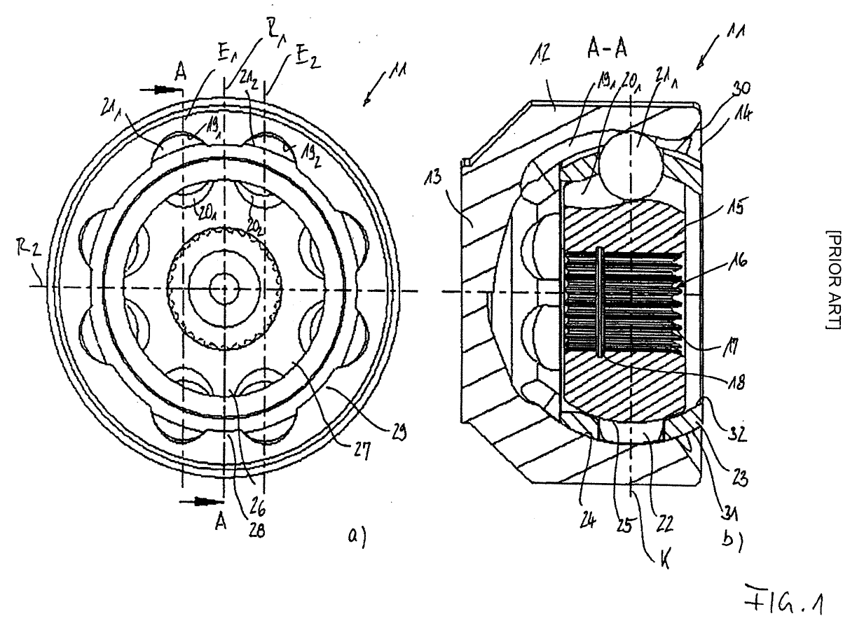

FIG. 1 shows a twin ball joint according to the state of the art in an aligned condition
a) in an axial view
b) in the form of a longitudinal section along sectional line A-A in illustration a).

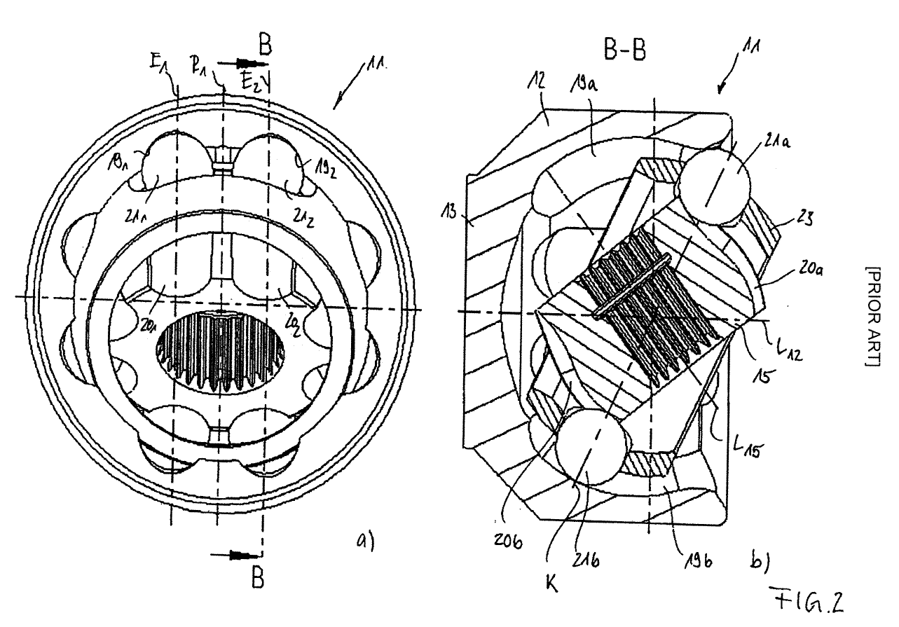

FIG. 2 shows a twin ball joint according to the state of the art in an articulated condition
a) in an axial view
b) in the form of a longitudinal section along the sectional line A-A in illustration a).

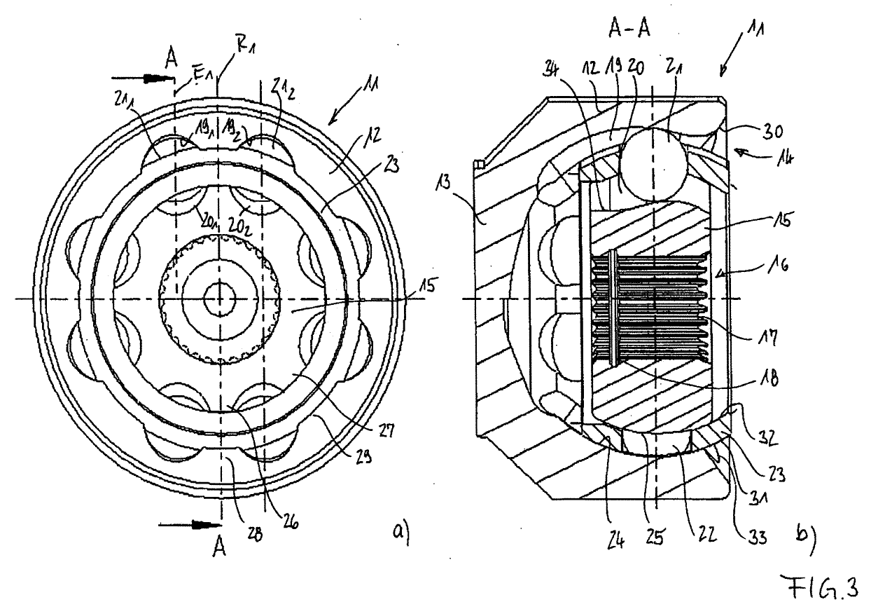

FIG. 3 shows an inventive twin ball joint in an aligned condition
a) in an axial view
b) in the form of a longitudinal section along sectional line A-A in illustration a).

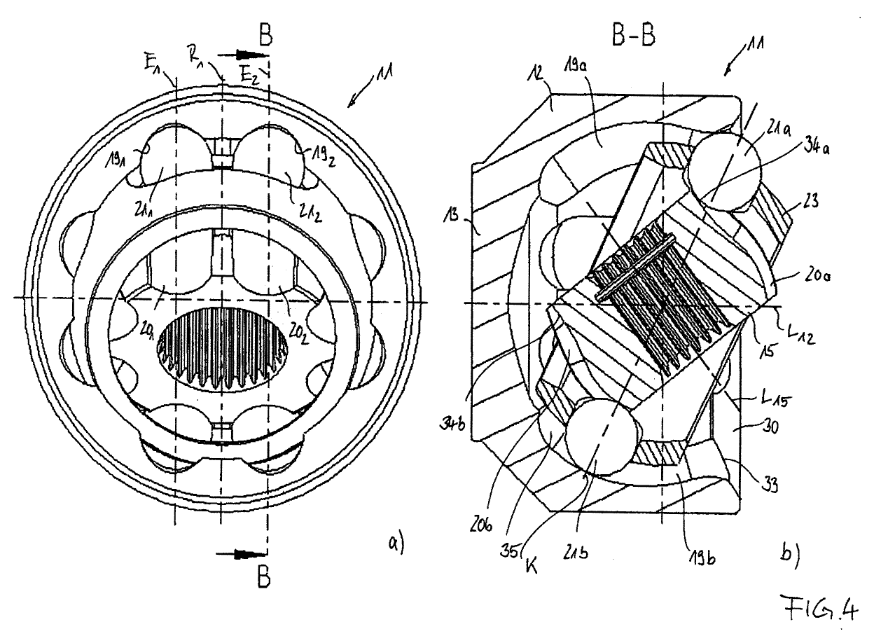

FIG. 4 shows an inventive twin ball joint in an articulated condition
a) in an axial view
b) in the form of a longitudinal section along sectional line A-A in illustration a).

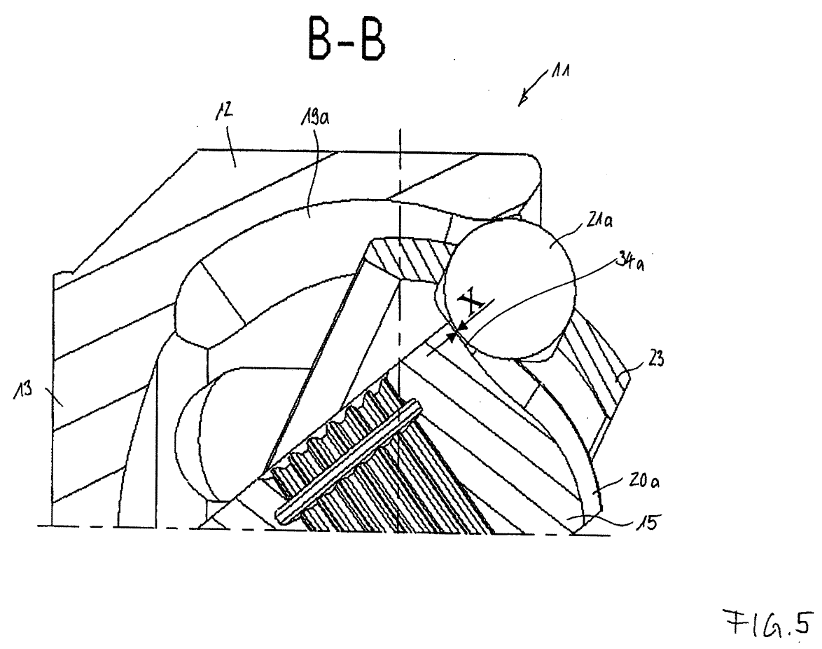

FIG. 5 shows details of FIG. 4) in an enlarged form.

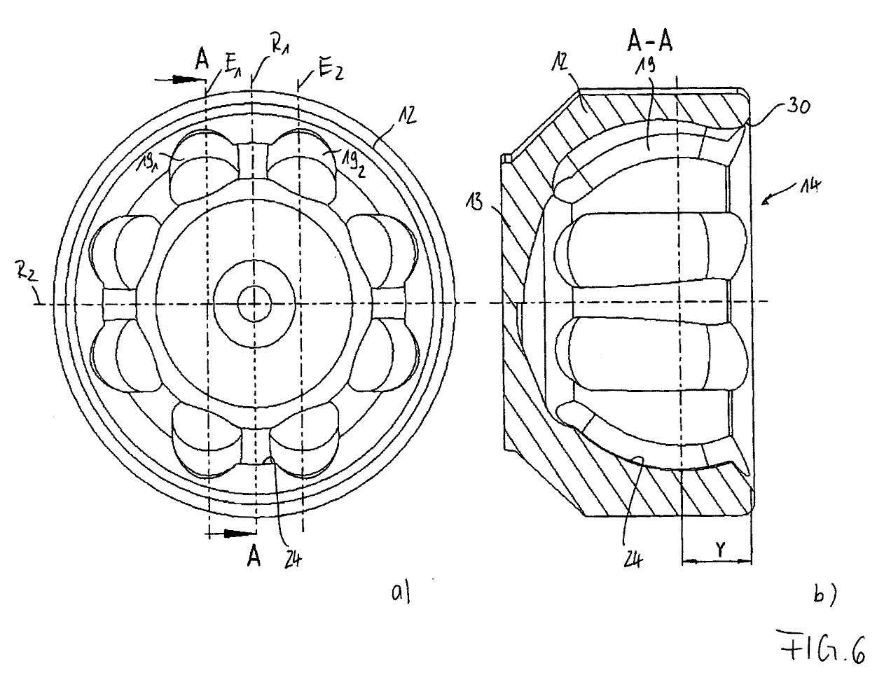

FIG. 6 shows the outer joint part according to FIG. 4b) in the form of a detail
a) in an axial view
b) in the form of a longitudinal section along sectional line A-A in illustration a).

The two illustrations in FIG. 1 will be described jointly below. There is shown a so-called twin ball joint wherein the longitudinal extensions of adjoining pairs of tracks are determined by parallel planes. With a total of eight circumferentially distributed balls it is possible to identify two pairs of parallel planes as the geometric locations of the centre lines of the tracks. Two of the planes E1, E2 are marked by dash-dotted lines which are positioned symmetrically relative to a first radial plane R1. A second radial plane R2 is positioned perpendicularly relative thereto without there being shown the planes, extending parallel thereto, of the associated ball tracks. The constant velocity universal joint 11 comprises an outer joint part 12 with a formed-on base 13 axially opposite to which there is positioned the joint opening 14. In the outer joint part 12, there is located an inner joint part 15 with an insertion opening 16 showing inner teeth 17 for the introduction of torque, and an annular groove 18 for axially securing a plug-in shaft. The outer joint part 12 comprises pairs of outer ball tracks 19₁, 19₂ and the inner joint part 15 comprises pairs of inner ball tracks 20₁, 20₂. The centre lines of said pairs of tracks are positioned in the planes E1, E2 and in the planes extending parallel to the radial plane R2. The pairs of tracks each receive balls 21₁, 21₂. The balls are received in pairs in the cage windows 22 of a cage 23, as can be seen in the offset section A-A in illustration b) in the lower half of the figure. In this part of the illustration it is also possible to see that the ball cage 23 is guided by means of its outer face 31 in a spherical inner face 24 of the outer joint part 12, into which spherical inner face 24 there are formed the outer ball tracks 19, and that the inner face 32 of the ball cage is guided on a spherical outer face 25 of the inner joint part 15. As can be seen from the circumferential distribution of the balls according to illustration a), narrower webs 26 between pairs of ball tracks in the inner joint part alternate with wider webs 27 between adjoining ball tracks in the inner joint part 15. Analogously, the same applies to the outer joint part 12, where narrower webs 28 between pairs of ball tracks alternate with wider webs 29 between adjoining ball tracks. The opening 14 of the outer joint part 12 is widened by an opening cone 30 which defines drawn-back track edges 33 at the ends of the outer ball tracks 19. In their longitudinal extension, the ball tracks 19, 20 comprise S-shaped centre lines (not shown) and a correspondingly S-shaped track base. The track centre lines and thus, in a wider sense, also the identifiable track base lines in the outer joint part 12 and in the inner joint part 15 are positioned symmetrically relative to a centre plane K containing the ball centres. In the inner joint part 15, the tracks 20 are outwardly curved relative to the joint opening end 14, with the track curvature towards the track base 13 being reversed.

In FIG. 2 any details identical to those shown in FIG. 1 have been given the same reference numbers. To that extent, reference is made to the description of FIG. 1. The inner joint part 15 is articulated relative to the outer joint part 12 by an articulation angle which is enclosed by the longitudinal axis L₁₂ of the outer joint part 12 and by the longitudinal axis L₁₅ of the inner joint part 15. The articulation angle is bisected by the centre plane K which contains the ball centres. The longitudinal axes L₂₁, L₁₅ define the articulation plane which corresponds to the plane R₁. The centre plane K which is predetermined by the ball cage 23 and by the position of the centres of the balls 21 bisects said articulation angle. In the sectional plane B-B which is positioned parallel to and close to the joint articulation plane, the ball 21a shown in the upper half of the figure has moved very close to the opening cone 30. It is in torque transmitting engagement with the end portion, at the opening end, of the outer ball track 19a and the end portion, at the joint base end, of the inner ball track 20a. As a result of the shape of the opening cone 30, the point of contact of the ball 21 with the track flank is very close to the track edge 33 (opening edge) of the outer ball track 19a, so that there is a risk of edge fracture. The ball 21b shown in the lower half of the figure has moved in the outer ball track 19b to its end facing the base, whereas in the associated inner ball track 20b it is held in the end region facing the opening. The point of contact with the track flank in the outer ball track 19b is far removed from the functional end of the outer ball track which, by the way, does not end in a free track edge, but changes into a track run-out. The points of contact of the balls with the track flanks of both inner ball tracks 20a, 20b are approximately equally far removed from the open track ends, with the corresponding axial distance being greater than in the case of the upper ball 21a relative to the outer ball track 19a because the inner ball tracks 20a, 20b at both ends are not affected by the end cone formations; in fact, they end in radial end faces of the inner joint part 15.

The two illustrations in FIG. 3 will be described jointly below; it shows a twin ball joint wherein the longitudinal extensions of adjoining pairs of tracks are determined by planes extending parallel relative to one another. With a total of eight circumferentially distributed balls, it is possible to identify two pairs of parallel planes as geometric locations of the centre lines of the tracks. Two planes E1, E2 are marked by dash-dotted lines which extend symmetrically to a first radial plane R1. A second radial plane R2 is positioned perpendicularly relative thereto, without the planes of the associated ball tacks, which planes extend parallel thereto, being indicated. The constant velocity universal joint 11 comprises an outer joint part 12 with a formed-on base 13 opposite which there is positioned the joint opening 14. In the outer joint part 12 there is positioned an inner joint part 15 with an insertion opening 16 in which it is possible to see inner teeth 17 provided for torque transmitting purposes, and an annular groove 18 for axially securing a plug-in shaft. The outer joint part 12 comprises pairs of outer ball tracks 19₁, 19₂ and the inner joint part 15 comprises pairs of inner ball tracks 20₁, 20₂. The centre lines of said pairs of tracks are positioned in the planes E1, E2 and in the planes extending parallel to the radial plane R2. The pairs of tracks each receive balls 21₁, 21₂. The balls are received in pairs in the cage windows 22 of a cage 23, as can be seen in the offset section A-A in illustration b) in the lower half of the figure. In this part of the illustration it is also possible to see that the ball cage 23 is guided by means of its outer face 31 in a spherical inner face 24 of the outer joint part 12, into which spherical inner face 24 there are formed the outer ball tracks 19, and that the inner face 32 of the ball cage is guided on a spherical outer face 25 of the inner joint part 15. As can be seen from the circumferential distribution of the balls according to illustration a), narrower webs 26 between pairs of ball tracks in the inner joint part alternate with wider webs 27 between adjoining ball tracks in the inner joint part 15. Analogously, the same applies to the outer joint part 12, where narrower webs 28 between pairs of ball tracks alternate with wider webs 29 between adjoining ball tracks. The opening 14 of the outer joint part 12 comprises an opening cone 30 which, together with the track cross-sections, defines set-back track edges 33 at the open track ends of the outer ball tracks 19. In their longitudinal extensions, the ball tracks 19, each comprise largely S-shaped centre lines (not illustrated) and a corresponding largely S-shaped track base. The track centre lines and thus, in a wider sense, also the identifiable track base lines, over a considerable axial range in the outer joint part 12 and in the inner joint part 15, extend symmetrically relative to a centre plane K containing the ball centres. In the inner joint part 15, the tracks 20 are outwardly curved towards the joint opening end 14, with the track curvature towards the joint base 13 initially being curved in the opposite direction and changing into an end portion 34 which has the shape of a straight line which tangentially adjoins the curved region, which end portion extends in an axis-parallel way and for which there is no equivalent in the end portion (at the opening end) of the outer ball track 19, which end portion is continuously curved as far as the track edge 33.

In FIG. 4 any details identical to those shown in FIG. 3 have been given the same reference numbers. To that extent, reference is made to the description of FIG. 3. The inner joint part 15 is articulated relative to the outer joint part 12 by an articulation angle which is enclosed by the longitudinal axis L₁₂ of the outer joint part 12 and by the longitudinal axis L₁₅ of the inner joint part 15. The articulation angle is bisected by the centre plane K which contains the ball centres. The longitudinal axes L₁₂, L₁₅ define the articulation plane which corresponds to the plane R₁. The centre plane K which is predetermined by the ball cage 23 and by the position of the centres of the balls 21 bisects said articulation angle. In the sectional plane B-B which is positioned parallel to and close to the joint articulation plane, the ball 21a shown in the upper half of the figure has moved very close to the opening cone 30. It has therefore been released from the torque transmitting engagement with the end portion of the outer ball track 19a, which end portion faces the opening end, and with the end portion 34 of the inner ball track 20a, which end portion faces the joint base; the centre lines of the two end portions do not extend mirror-image-like relative to the centre plane K. As a result, the ball 21a in the pair of tracks comprises a radial play and therefore also circumferential play. As a result of the shape of the opening cone, the point of contact of the ball 21a with the track flank is very close to the track edge 33 (opening edge) of the outer ball track 19a, which ball track is completely relieved from ball forces. The play-free transmission of torque is carried out by the remaining balls. The ball 21b shown in the lower half of the figure has moved in the outer ball track 19b to the end facing the base, whereas it is held in a torque transmitting way in the associated inner ball track 20b in the end region facing the opening end. The centre lines of said end regions extend symmetrically relative to the centre plane K. The point of contact of the ball with the track flank in the outer ball track 19b is far removed from the functional end of the outer ball track which, by the way, does not end in a free track edge and changes into a track run-out 35. The points of contact of the balls with the track flanks of both inner ball tracks 20a, 20b are removed by approximately the same distance from the open track ends, with the corresponding axial distance being greater than in the case of the upper ball 21a relative to the track edge 33 of the outer ball track 19a, because the inner ball tracks at both ends extend as far as the radial end faces of the inner joint part.

It can be clearly seen in FIG. 5 that the end of the outer ball track 19, which end faces the opening, continues the S-shaped track course as far as the opening cone 30, which opening cone in this region is inwardly convex, whereas the end portion 34 of the inner ball track 20a, which end portion 34 faces the base and cooperates therewith, deviates from the symmetrical extension and is deepened and provided in the form of a straight line tangentially adjoining the shortened “S”. As a result, there occurs a radial play X and it is arbitrarily assumed that the ball 21a moves outwardly under the influence of a centrifugal force. As a transmission of force takes place via the track flanks, this means at the same time, that the ball 21a is lifted radially upwardly out of the track 20a whose cross-section has been largely adapted to that of the ball, so that the ball is relieved from a transmission of torque. As a result, the point of contact of the ball with the track flank of the outer ball track 19a is able to move as far as the open track edge 33 which is defined by the opening cone 30 and the track cross-section, without there being any risk of fracture for the track edge 33. An essential aspect of achieving such an effect consists in relieving the ball from the simultaneous contact with the diagonally opposed track flanks of the ball tracks 19a, 20a. This means that for example also the inner ball track 20a could be continued in an S-shaped way as far as the base end and the outer ball track 19a, at the opening end, could be deepened relative to the track shape indicated. It is also conceivable that instead of deepening the end portion of one of the tracks, the cross-section of one of the ball tracks would be widened in order to remove the ball in the articulation plane out of a torque transmitting position, whereas balls further removed from the articulation plane could be guided in their pairs of inner and outer ball tracks in a play-free and torque transmitting way between the track flanks.

FIG. 6 shows the outer joint part 12 according to FIGS. 3 and 4 in the form of a detail in an offset section A-A. Identical details have been given the same reference numbers. To that extent, reference is made to the above descriptions. The axial distance between the centre plane K and the exit of the track base of the outer ball track 19 into the opening cone 30 is referred to as Y. In accordance with the invention, this dimension can be minimised relative to a joint according to the state of the art.

1. A constant velocity universal joint assembly comprising:
an outer joint part with outer ball tracks;
an inner joint part with inner ball tracks;
torque transmitting balls which are held in pairs of outer and inner ball tracks associated with one another;
a ball cage which receives said balls in cage windows and holds same in a common central plane K;
wherein the course of said outer ball tracks and the course of said inner ball tracks associated with one another extend mirror-symmetrically relative to said central plane K;
wherein at least one axial end portion of said inner and outer ball tracks has a shape such that a ball entering said axial end portion when the joint is articulated is freed from the transmission of torque between the associated outer and inner ball tracks.

2. An assembly according to claim 1, wherein in at least one group of said outer and inner ball tracks, the course of the tracks of said axial end portions is deepened relative to a theoretical track course which is mirror-symmetrical with respect to the tracks of said associated inner or outer ball tracks.

3. An assembly according to claim 1, wherein in at least one group of said outer and inner ball tracks, the track cross-section of said axial end portions is widened relative to a theoretical cross-section which would receive said balls with said track cross-section of the associated inner or outer ball tracks in a play-free way.

4. An assembly according to claim 1 wherein the ball tracks of one group of said outer and inner ball tracks extend in an S-like way and that said axial end portion of the other group of said outer and inner ball tracks is deepened in the shape of a straight run-out.

5. An assembly according to claim 1, wherein said outer joint part is closed on one side by a base and that said axial end portion is provided at the end of said outer ball tracks facing an aperture or at the end of the inner ball tracks facing a base.

6. An assembly according to claim 1, wherein said ball tracks are spaced non-uniformly around the a circumference, such that webs of different widths are provided between adjoining ball tracks.

7. An Assembly A joint according to wherein at least two balls each are arranged in a common cage window and that webs with a smaller width are positioned between ball tracks of balls which are arranged in a common cage window.

8. An assembly according to claim 1, wherein said torque transmitting belts comprise eight balls which are arranged in four cage windows.

9. An assembly according to claim 1, wherein said ball tracks are separated by a web of smaller width and extend in planes E1, E2 extending parallel relative to one another.

10. An assembly according to claim 1, wherein an inner opening cone in the opening of said outer joint part has a maximum size being such that the face of said cone is reached by the point of contact of said balls with the track flanks of outer ball tracks just at maximum articulation.

11. A constant velocity universal joint assembly comprising:
an outer joint part with outer ball tracks;
an inner joint part with inner ball tracks;
torque transmitting balls which are held in pairs of outer and inner ball tracks associated with one another;
a ball cage which receives said balls in cage windows and holds same in a common central plane K;
wherein the course of said outer ball tracks and the course of said inner ball tracks associated with one another extend mirror-symmetrically relative to said central plane K;
wherein at least one axial end portion of said inner and outer ball tracks has a shape such that a ball entering said axial end portion when the joint is articulated is freed from the transmission of torque between the associated outer and inner ball tracks;
wherein in at least one group of said outer and inner ball tracks, the course of the tracks of said axial end portions is deepened relative to a theoretical track course which is mirror-symmetrical with respect to the tracks of said associated inner or outer ball tracks.

12. A constant velocity universal joint assembly comprising as described in claim 11, wherein the ball tracks of one group of said outer and inner ball tracks extend in an S-like way and that said axial end portion of the other group of said outer and inner ball tracks is deepened in the shape of a straight run-out.

13. A constant velocity universal joint assembly comprising as described in claim 11, wherein said outer joint part is closed on one side by a base and that said axial end portion is provided at the end of said outer ball tracks facing an aperture or at the end of the inner ball tracks facing a base.

14. A constant velocity universal joint assembly comprising as described in claim 11, wherein said ball tracks are spaced non-uniformly around the a circumference, such that webs of different widths are provided between adjoining ball tracks.

15. A constant velocity universal joint assembly comprising as described in claim 11, wherein said torque transmitting belts comprise eight balls which are arranged in four cage windows.

16. A constant velocity universal joint assembly comprising:
an outer joint part with outer ball tracks;
an inner joint part with inner ball tracks;
torque transmitting balls which are held in pairs of outer and inner ball tracks associated with one another;
a ball cage which receives said balls in cage windows and holds same in a common central plane K;
wherein the course of said outer ball tracks and the course of said inner ball tracks associated with one another extend mirror-symmetrically relative to said central plane K;
wherein in at least one axial end portion of said inner and outer ball tracks has a shape such that a ball entering said axial end portion when the joint is articulated is freed from the transmission of torque between the associated outer and inner ball tracks;
wherein in at least one group of said outer and inner ball tracks, the track cross-section of said axial end portions is widened relative to a theoretical cross-section which would receive said balls with said track cross-section of the associated inner or outer ball tracks in a play-free way.

17. A constant velocity universal joint assembly as described in claim 16, wherein the ball tracks of one group of said outer and inner ball tracks extend in an S-like way and that said axial end portion of the other group of said outer and inner ball tracks is deepened in the shape of a straight run-out.

18. A constant velocity universal joint assembly as described in claim 16, wherein said outer joint part is closed on one side by a base and that said axial end portion is provided at the end of said outer ball tracks facing an aperture or at the end of the inner ball tracks facing a base.

19. A constant velocity universal joint assembly as described in claim 16, wherein said ball tracks are spaced non-uniformly around the a circumference, such that webs of different widths are provided between adjoining ball tracks.

20. A constant velocity universal joint assembly as described in claim 16, wherein said torque transmitting belts comprise eight balls which are arranged in four cage windows.
